(19) United States
(12) Patent Application Publication
(10) Pub. No.: US 2005/0251830 A1
(43) Pub. Date: Nov. 10, 2005

(54) Method of solving a conflict

(76) Inventors: Judith Agnes Josephina Peeten, Eindhoven (NL); Marco Van Leeuwen, Eindhoven (NL); Yasmina Haryono, Eindhoven (NL); Rogier Louis Jacques Willem Thissen, Leuven (BE); Frederik Johan Leon Leemans, Leuven (BE)

Correspondence Address: U S Philips Corporation;Intellectual Property Department, P O Box 3001, Briarcliff Manor, NY, 10510, US

(21) Appl. No.: 10/498,961

(22) PCT Filed: Dec. 5, 2002
(86) PCT No.: PCT/IB02/05224

§ 371 Date: Jun. 16, 2004

(30) Foreign Application Priority Data
Dec. 21, 2001 (EP) 01205136.3

(51) Int. Cl. H04N 5/445

(52) U.S. Cl. 725/58

(57) ABSTRACT

The present invention relates to a method of solving a conflict, the method comprising the steps of selecting (210) a program item and specifying at least one intended operation for said program item, determining (230) whether or not said operation can be performed without a conflict with at least one earlier specified item, choosing (270) which program item is to be operated and setting (280) data implementing that choice. According to the method of the invention, the method comprises a step (260) of executing an interactive game program to resolve the conflict. The invention also relates to a system for processing program items, the system performing the method of the present invention.

The present invention relates to a method of solving a conflict, the method comprising the steps of selecting a program item and specifying at least one intended operation for said program item, determining whether or not said operation can be performed without a conflict with at least one earlier specified item, choosing which program item is to be operated, and setting data implementing that choice.

The invention also relates to a system for processing program items, the system comprising selection means for selecting a program item and specifying means for specifying at least one intended operation for said program item, conflict determination means for determining whether or not said operation can be performed without a conflict with at least one earlier specified item, choosing means for choosing which program item is to be operated, and setting means for setting data implementing that choice.

An embodiment of such a method is known from EP-0969661A1. The method disclosed in this document provides a technology for apparatus used in an audio and visual apparatus system (AV apparatus system) to enable a plurality of AV apparatuses in conjunction with one another to easily make timed reservations and accomplish reservation management. According to the document, an availability or unavailability of the apparatuses is determined for a desired period of time. When the apparatus is unavailable to be used between a starting time and an ending time, there is a conflicting request for the use of the apparatus. The apparatus further performs processing operations such as determining which request should be validated. The method known from the document aims at avoiding a conflict between the requests for use of the same apparatus. The known method comprises a step of determining if the related apparatus is scheduled for use in designated hours of reservation and another step where an operator is asked if the timed reservation is to be revised or canceled. In one of the embodiments, the operator is notified about the conflict between reservations and asked in the form of a dialog which reservation is to be given priority. In the case when the reservation is canceled, it is so disposed that the apparatus whose reservation is canceled deletes reservation data concerning the reservation.

There are many conflict situations, which can occur in the system when one or more users would like to perform one or several actions like watching, recording, storing e.g. with TV, radio programs or other broadcast information at the desired period of time in future or at the present moment. In some situations, such scheduling cannot be performed for the particular desired time or intended action with the program. Currently known systems often propose one or several dialogs to the user to solve the conflict. When there are many users and the conflicting requests originate from different users, then participation of more than one user in the solution of the conflict is desired. It is a drawback of the known prior art that the users are provided with a limited number of restricted ways to solve the conflicts described above.

It is an object of the invention to provide a method of solving a conflict of the kind defined in the opening paragraph, which contemplates enhanced and dynamic possibilities to solve a conflict, wherein said possibilities comprise a solution of conflict in a social, pleasant and interactive way. Said conflict appears when a specified operation cannot be performed with a selected program item. This object is realized in that the method of the present invention comprises a step of executing an interactive game program to solve the conflict.

When the conflict is determined, the user is invited to play the interactive game program. Thus, the user can choose to play the game program for solving the conflict rather than to be offered the dialog known in the prior art.

An embodiment of the method of the present invention also comprises a step of selecting a different interactive game program depending on a conflict condition and the successive step of executing the selected interactive game program. In some conflict situations, a specific type of interactive game program with certain parameters like duration, topic, outcome, etc. is necessary to select from a variety of the games for further executing.

A further embodiment of the method comprises at least one step of defining, storing and modifying at least one condition of choosing which program item is to be operated. Indeed, the condition for choosing the program item should be satisfied or not after obtaining results of executing the interactive game program, and that condition should be defined in the system beforehand. The results can be deduced from the rating systems widely used in the games known in the prior art. Such rating systems can be designated to rate an individual players performance based on their own skills, provide a measure of how well players are progressing through the game and so on. For example, points or scores can be allocated to the players of the games using such rating systems. A higher result achieved in the game by the user can serve as the condition for choosing the corresponding program item. If the higher result is achieved, the condition could be properly modified and used for comparison with the results that would be achieved in future. More than one condition can be defined and also related to a user behavior.

A further embodiment of the method comprises a step of identifying an identity of at least one of a plurality of the users, for solving a conflict among said plurality of users.

The system according to the invention is characterized in that the system comprises means for executing an interactive game program to solve the conflict.

These and other aspects of the invention will be further elucidated and described with reference to the accompanying drawings, wherein:

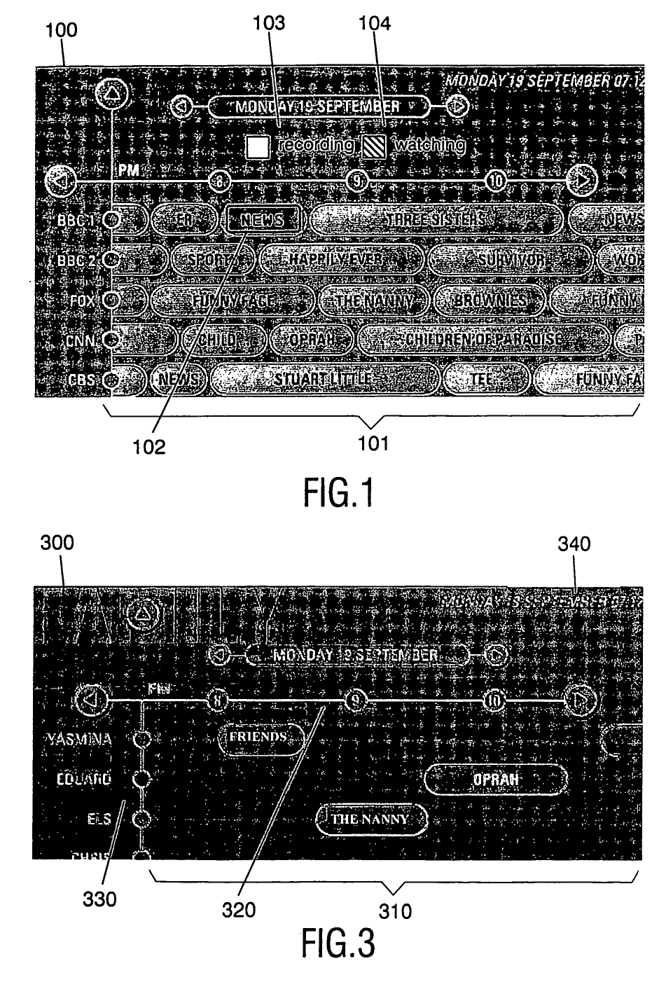

FIG. 1 shows an embodiment of the method for the solution of the conflict, in which a flow chart of a time conflict solution is shown;

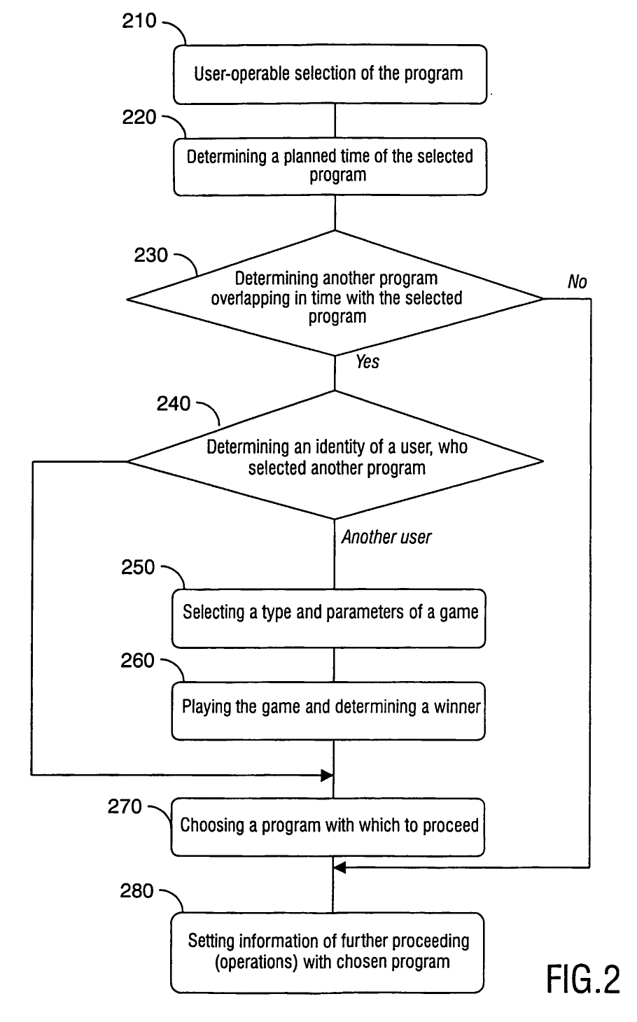

FIG. 2 shows an embodiment of the method for the conflict solution, wherein the selected program item and the intended operation for said program item are shown;

FIG. 3 shows an embodiment of the method for the conflict solution, wherein the earlier specified program items are shown;

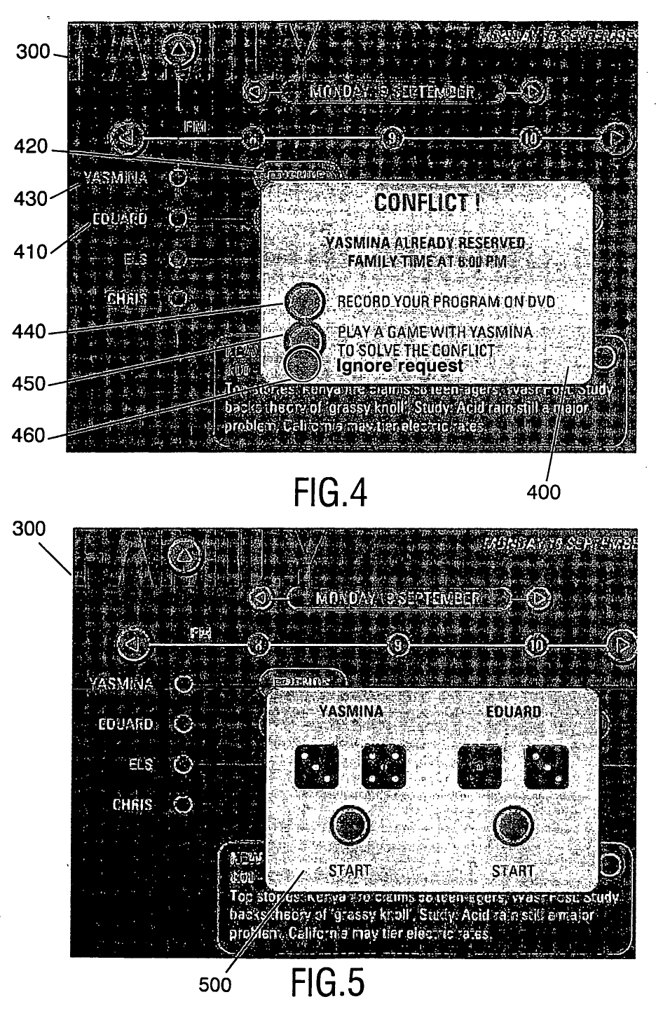

FIG. 4 shows an embodiment of the method for the conflict solution, wherein the user is notified that the selected program item is conflicting in time with one of the earlier specified programs, and the user is also invited to play the game;

FIG. 5 shows an embodiment of the method for the conflict solution, wherein the interactive game program is being executed;

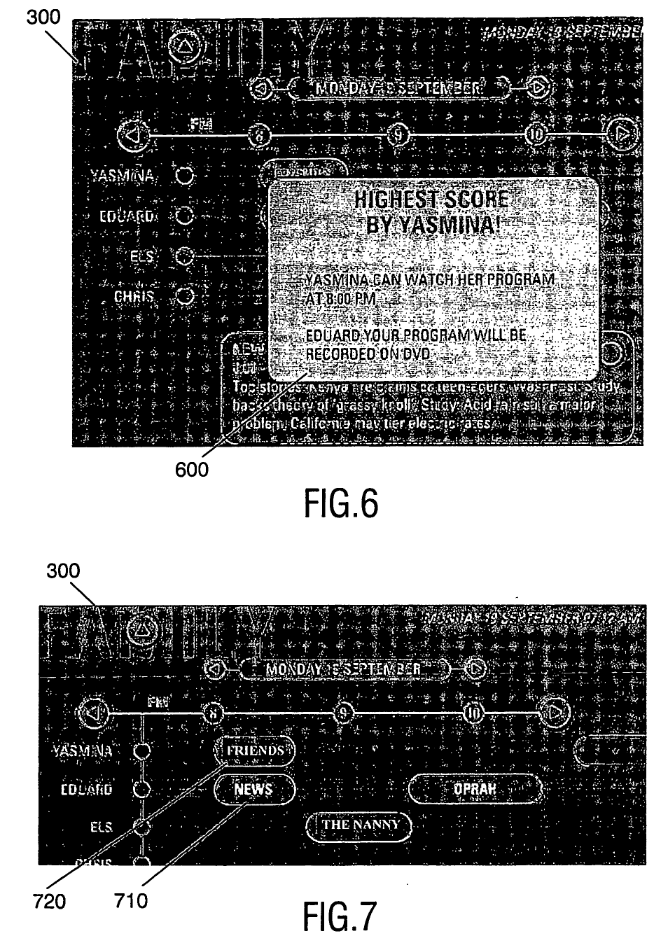

FIG. 6 shows an embodiment of the method for the conflict solution, wherein the user is notified which program item is to be operated;

FIG. 7 shows an embodiment of the method for the conflict solution, wherein another operation is specified upon said selected program item;

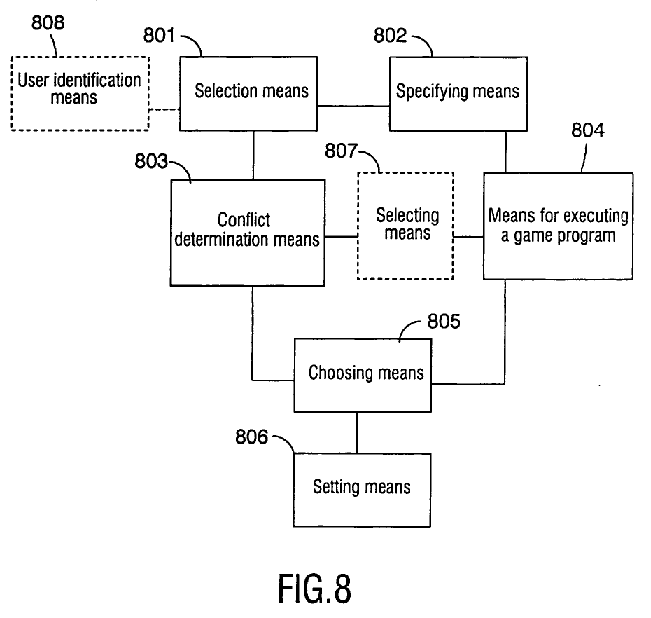

FIG. 8 shows a functional block diagram of the system of the present invention.

FIG. 1 shows an embodiment of the method of the present invention, as applied to an EPG field. In this case, a particular TV program corresponds to the term “program item” of the method. A frame 100 showing the program guide is displayed. A variety of the programs forms program information 101 that is presented in a grid with time and channel axes. Said grid can be scrolled vertically and horizontally for viewing the program information for another time period and/or channels. On the frame 100, the program 102 is selected and two operations of watching 104 and recording 103 are available in the program. The watching choice 104 is specified for the selected program 102 as an example to explain the present invention.

The flow chart of FIG. 2 comprises an example of a description of steps for resolving a conflict. A user selects a program item and specifies at least one operation upon said program item in step 210. A selection of the program item can be performed by the user or without a direct participation of the user i.e. by an apparatus implementing the method of the present invention. The operation for the selected program item is specified from a list of available operations, e.g. recording, watching.

According to step 220, a planned time of the selected program should be determined for further purposes: either said program will be broadcast in future at the time according to a program schedule, or it is being broadcast now, or the program has completely or partly been stored in a memory. Thus, different conflicts can be found depending on the time period of the selected program.

In step 230 of the method, it is to be determined whether or not the specified operation for the selected program item can be performed without a conflict with at least one earlier specified item. One of the known methods of determining the conflicting items can be found in U.S. Pat. No. 6,061,503. If in step 230 the conflict is determined that a first program which was selected earlier is overlapping in time with a second selected program for the same specified operation, the identity of a user who selected the first program earlier will be determined in step 240. Otherwise, step 280 is further executed, wherein the specified operation for the selected program is performed, as it is known in the prior art.

According to the present embodiment, different users, who can specify different or the same operations for different or the same selected programs, can be identified. Thus, at least three conflict situations are possible when the second program is selected for the specified operation:
a) the user has already scheduled performing the specified operation for the first program for the specified period of time;
b) another user has already scheduled performing the specified operation for the first program for the specified period of time;
c) the user wants the specified operation to be performed for the second program immediately after the moment of selecting the second program, but the specified operation is already being performed for the first program at the same moment, and the first program was selected by the other user.

Only a solution of the conflicts wherein one of the conflicting programs was selected earlier will be further considered. The solution of a conflict wherein the user is watching, recording, etc. the first program and the same user specifies the same operation for the second program at the same moment is known in the prior art and will not be considered in this document.

Step 250 is executed if according to step 240 the users who selected the first and second program items are different users. If the conflicting program items are selected by the same user, step 270 is to be further executed. There is no need to execute the game when the same user selected the first and second conflicting program items. It can be done, as is known in the prior art, by providing the simple dialog in which the user is invited to choose one of the conflicting programs.

In step 250, the parameters and types of the game program are to be selected depending on the conditions of the conflict. For instance, the conditions of the conflict may be defined as depending on:
1) a maximum playing time that can be limited by the start of any of the conflicting program items;
2) a number of the earlier specified program items conflicting with the first selected program item, the choice should be made between all of these items;
3) an identity and number of users who selected the earlier specified program items;
4) the executed game can be selected depending on characteristics of the program items; for example, the TV programs can be divided into categories like news, movies, entertainment, sports, sport news etc, and a scene and/or topic of the game can be related with the category of one of the conflicting programs.

The parameters of styles, subjects, time duration, number of players, outcomes and other characteristics of the game programs can be related with the condition of the conflict. For instance, in the conflict situation, in which the choice between the program items should be made as quickly as possible, a type of game such as a “random choice” can be selected for further execution. Such a situation may occur when one of the conflicting programs is already being watched, recorded, etc. Lotto games, a game of dice may be examples of the “random choice” games. In fact, there are many examples of games that can be used for the solution of conflicts. Some of them are single-player games: lotto games, puzzle games, arcade games, dice, tetris, games with a virtual opponent and others. Other games are for multiple players: family games, role playing games, strategy games, action games, etc.

After step 250, the game program is executed in step 260 and the winner of the game is determined in order to choose in step 270 the program item with which to proceed further to step 280. It is much more attractive and interesting to play the game and in this way to resolve the conflict, rather than in all conflict situations to be just offered the dialog known in the prior art.

To summarize, the following solutions are proposed in the above-mentioned three conflict situations:
a) the user is invited to choose which program item is to be operated without step 260 of executing the interactive game program and step 250; a choice can be made via the simple dialog known in the prior art;
b) and c) the users who selected the conflicting program items are different and steps 250, 260 will be executed.

Different criteria can be formulated in step 270 for choosing the program item to be operated. Many games have game results, which can be associated with one or more users. If two players are playing the game, their achieved results, performances, skills of playing are different and can be rated, “measured” during the game or at the end of the game, as is known in the prior art, so that a winner of the game can be recognized. One or more players of the game may be virtual players and thus it is also possible that only one user plays the game. The results obtained in step 260 for choosing which program item is to be operated in step 270 can be a payoff or outcome of the game or an intermediate result of the game, which is not executed to the end. The outcome is the state of the game at its conclusion. The payoff could be defined as a win or loss; and also a ranking as in the game with many players.

In step 280 data are set to implement the choice made in step 270. For instance, the apparatus related to the corresponding specified operation could be instructed to start and end performing the specified operation for the program item chosen in step 270 at the period of time determined in step 220.

Of course, the steps of the embodiment shown in FIG. 1 can be applied to a plurality of operations like watching, recording, which can be performed for the program items.

A further embodiment of the method comprises the steps of storing and modifying at least one condition of choosing which program item is to be operated. Obviously, the condition should be defined before it is used for choosing one of the conflicting program items. Afterwards, the condition is further modified depending on the results of executing the interactive game program and/or a user behavior. It could be implemented that several one-player games are provided with the television system and the system divides all program items of the program schedule into the categories. The items can be divided by channels of the TV program listings, for example. The system may further associate available games with at least one of the available TV channels. The users can individually play in any of the available games and their highest ratings will be saved and stored in the memory. In this way, the condition for choosing the program items can be stored and modified each time when the individual user achieves the result which is higher than the results achieved before. More than one of said conditions could be used.

In another embodiment of the present invention, the user can choose to play the one-player game when the selection of the program item is being performed, and the obtained result will be stored in the memory and associated with that particular reservation of the program item. If the conflict with that reserved item occurs and another user would like to schedule another program item for the same period of time, the other user will be asked to play the same game, and the result of the other user will be compared with the result retrieved from the memory.

In a further embodiment of the present invention, the condition of choosing which program item is to be operated comprises a user priority. Said priority is to be established, stored and further modified. For example, such a priority can be used between users of family members, adults and children, etc.

In another embodiment of the present invention, the condition of choosing which program item is to be operated is further modified depending on user behavior. It is known to analyze user behavior and store user profile data, which characterize user preferences and characteristics. Obviously, the user that likes to watch sport programs may also like to play sports games. The embodiment of the method may further comprise a step of proposing the types of games that are closest to the user preferences stored in the user profile data. In turn, the behavior of a user playing the particular game can be analyzed and the user profile data can be modified accordingly.

In a further embodiment of the present invention, the method comprises a step of avoiding that one of the users cannot schedule any of the desired program items. For example, this may happen when the user always/often loses in the games and/or the program item selected by the user is never or hardly ever chosen. In such cases, the higher user priority can be given to this user, or other steps can be taken. The method may also comprise a step of providing more favorable conditions under which the game begins/is executed for said user. Thus, in another embodiment of the invention, the conditions, under which the games begin/are executed, can be varied and applied to all players, some of the players or the single player.

In a further embodiment of the present invention, the step of modifying at least one condition of choosing which program item is to be operated comprises deleting data related to the results obtained by the user when said user does not select and/or schedule the program items for a predetermined period of time, when one of the users would like to delete results achieved by him and other similar situations.

One of the possible implementations will now be described as applied to the EPG field. FIG. 3 shows a frame 300, in which TV programs 310 are indicated in a grid with the time axes 320 and an axis 330 with names of family members using TV set with the EPG. Thus, an overview of the TV programs 310 which have already been scheduled for watching and recording at a particular time and date 340 is provided in the frame 300. In FIG. 4, the user who selected the program item is informed in the form of a message frame 400 on the frame 300 that one of the earlier specified programs is already scheduled for watching at the same period of time. Particularly, the users are notified that the program item 102 selected by a first user 410 is conflicting in time with the program item 420 earlier specified by a second user 430. The first user 410 is invited to make one of three choices: a choice 440 to record the selected program, a choice 450 to play the game with the second user, a choice 460 to terminate further proceeding with the program 102 selected by the first user 410. The conflict will be avoided if the first user selects the choice 440 to record the program. It is assumed that the first user further selects the choice 450. In FIG. 5, a frame 500 on the frame 300 is displayed which shows that the interactive game program is being executed. The first and second users play the game of dice to choose which of the programs will be scheduled. The frame 500 shows that at the end of the game the first user 410 has a lower score than the second user 430. If the second user is not participating in the game, it is still possible to execute the interactive game program as described in one of embodiments mentioned above. In FIG. 6, a frame 600 on the frame 300 shows that the second user 430 won the game and the first user 410 is invited to make the recording choice 440 for his/her program in order to resolve the conflict. FIG. 7 shows on the frame 300 that the program 102 selected by the first user 410 is scheduled as the program 710 to be recorded, the program 420 of the second user 430 remaining in a list of the TV programs 310 scheduled earlier for watching and recording.

FIG. 8 shows a functional block diagram of a system of the present invention. The system comprises selection means 801 for selecting a program item and specifying means 802 for specifying at least one intended operation for said program item. Conflict determination means 803 determines whether or not said operation can be performed without a conflict with at least one earlier specified item. The program item to be operated can be chosen by choosing means 805 and data implementing that choice can be set by setting means 806. The system is characterized in that it comprises means 804 for executing an interactive game program to resolve the conflict.

The number of the operations for the selected program item, which can be performed simultaneously, may be limited. Said number could be related to the number of tuners/receivers or other devices, which provide program information to the system, and could also be dependent on a variety of devices for performing said operations, which are available in the system.

In one of the embodiments of the system, the system further comprises selecting means 807 for selecting a different interactive game program depending on a conflict condition. For example, different kinds of games can be selected relative to the channel on which the selected program is broadcast. As an example, said means can be implemented with a software program, as is known in the prior art.

In another embodiment of the system, the system comprises user identification means 808 for identifying an identity of at least one of a plurality of the users. Said means can be implemented by means for recognizing of user's fingerprints on a remote control device, or the system can be adapted to recognize the remote control devices associated with the individual users, while other techniques could be used for the user identification as well.

In a further embodiment of the system, the system comprises means (not shown) for creating, modifying and storing user profile data comprising data related to user behavior and the results achieved by the users playing the interactive games. Said means are well known in the prior art and are not described in this document.

In a further embodiment of the system, the user is orally asked questions and the system can acoustically receive and process a user answer. In that way, the system can acoustically communicate with the user and may not use tangible tools for communication purposes.

The system of the present invention can also be realized with the remote control device comprising a display unit and user input means. In that way, the program items are visually presented to the user on the display unit, the user can select one of the program items and specify at least one intended operation for the selected program item by using said input means. The interactive game program is executed, using the display unit and user input means to resolve the conflict as described above.

The object of the invention is achieved in that the method, the system and various embodiments are provided with reference to the accompanying drawings. The invention allows resolving the conflict in a social way with fun, pleasure to use and by connecting people.

The various program products may implement the functions of the system and method of the present invention and may be combined in several ways with the hardware, or they may be located in different devices. Variations and modifications of the described embodiment are possible within the scope of the inventive concept.

1. A method of solving a conflict, the method comprising the steps of selecting (210) a program item and specifying at least one intended operation for said program item, determining (230) whether or not said operation can be performed without a conflict with at least one earlier specified item, choosing (270) which program item is to be operated and setting (280) data implementing that choice, characterized in that the method comprises a step of
executing (260) an interactive game program to resolve the conflict.

2. The method of claim 1, further comprising a step (250) of selecting a different interactive game program depending on a conflict condition and the successive step (260) of executing the selected interactive game program.

3. The method of claim 1, wherein the step (260) of executing the interactive game program comprises obtaining results for choosing which program item is to be operated.

4. The method of claim 3, further comprising at least one step of defining, storing and modifying at least one condition of choosing which program item is to be operated.

5. The method of claim 4, wherein said condition is further modified depending on the results of executing the interactive game program and/or a user behavior.

6. The method of claim 5, comprising a step (240) of identifying an identity of at least one of a plurality of the users, for solving a conflict among said plurality of users.

7. A system for processing program items, the system comprising selection means (801) for selecting a program item and specifying means (802) for specifying at least one intended operation for said program item, conflict determination means (803) for determining whether or not said operation can be performed without a conflict with at least one earlier specified item, choosing means (805) for choosing which program item is to be operated and setting means (806) for setting data implementing that choice, characterized in that the system comprises means (804) for executing an interactive game program to resolve the conflict.

8. The system of claim 7, further comprising selecting means (807) for selecting a different interactive game program depending on a conflict condition.

9. The system of claim 7, further comprising user identification means (808) for identifying an identity of at least one of a plurality of the users, for resolving a conflict among said plurality of users.

10. A computer program product enabling a programmable device when executing said computer program product to function as the system defined in claim 7.
